(19) United States
(12) Patent Application Publication
(10) Pub. No.: US 2006/0231977 A1
(43) Pub. Date: Oct. 19, 2006

(54) Compression molding process

(76) Inventor: Terry J. Nicholas, E. Grand Rapids, MI (US)

Correspondence Address: Price, Heneveld, Cooper, DeWitt & Litton, LLP;695 Kenmoor, S.E., Post Office Box 2567, Grand Rapids, MI, 49501, US

(21) Appl. No.: 11/403,721

(22) Filed: Apr. 13, 2006

Related U.S. Application Data
(60) Provisional application No. 60/670,925, filed on Apr. 13, 2005.

(51) Int. Cl. B29C 45/14

(52) U.S. Cl. 264/255; 264/259; 264/328.7; 264/328.8

(57) ABSTRACT

A compression molding process incorporates a reciprocating screw plasticator to reduce or eliminate problems associated with variations in the amount of time that a thermoplastic material is maintained in a plasticated state. The process includes providing a thermally controlled mold having a first section and a second section which together define a mold cavity, plasticating thermoplastic material in a reciprocating screw extruder, depositing a mass of plasticated thermoplastic material from a nozzle at the discharge end of the plasticator onto one of the sections of the mold, closing the mold sections together to shape the plasticated mass of material, cooling the thermoplastic material in the mold cavity to solidify a thermoplastic article, and removing the shaped article from the mold.

### CROSS-REFERENCE TO RELATED APPLICATION

This application claims priority under 35 U.S.C. § 119(e) of U.S. Provisional Application No. 60/670,925 entitled COMPRESSION MOLDING PROCESS, filed Apr. 13, 2005, the entire disclosure of which is incorporated herein by reference.

### FIELD OF THE INVENTION

This invention pertains to compression molding methods and apparatus for making thermoplastic articles that cannot be easily and economically made using conventional injection molding or extrusion techniques.

### BACKGROUND OF THE INVENTION

Thermoplastic articles having a relatively large dimension (e.g., a length of several feet) cannot be easily or economically made using injection molding techniques. Among the problems associated with injection molding thermoplastic articles having a relatively large dimension are various issues relating to the massive steel molds typically needed to withstand the high clamping pressures normally employed during such processes. Such molds are expensive and require heavier duty handling equipment (e.g., mold opening, closing and conveyance devices), more energy to heat the mold to an appropriate molding temperature, and more time to cool from a molding temperature to a temperature at which the thermoplastic has solidified and can be removed from the mold. Because of the longer time required for heating and cooling, cycle times (time between removal of successive products from molds in a production line) are also very long. All of these factors make injection molding a prohibitively expensive process for many products having a relatively large dimension.

Injection molding techniques are also unsuitable for making thermoplastic articles containing aesthetic particle materials (e.g., metal flakes) that are intended to be visible at a surface of the article. It is generally all but impossible to achieve a uniform distribution of particles at the surface of an injection molded thermoplastic article due to non-uniform flow of the thermoplastic material as it is injected into the mold, such that injection molded thermoplastic parts having visible, decorative particles have an unacceptable surface appearance.

The problems discussed above can generally be overcome by employing extrusion techniques provided that the article has a substantially constant transverse cross-sectional shape, and provided that the article does not include discrete inserts that do not extend continuously through the length of the extrudate. It is all but impossible to extrude an article having ends with a geometry that is substantially different from the transverse cross-sectional shape of the portion of the article between the ends. Techniques used to separately mold the ends and subsequently attach the ends to a main portion of the article have been expensive, requiring additional steps and manufacturing apparatus, and have produced articles with an aesthetically undesirable or unacceptable appearance due to visible seams where the ends have been attached (e.g., typically with adhesives or an additional fusion step).

The various problems associated with making thermoplastic articles having a relatively large dimension or aesthetic particles at a surface of the article, and discrete inserts and/or ends having a shape different from the portion between the ends, have been overcome to a large extent utilizing the methods and means for molding plastic parts that are described in U.S. Pat. No. 4,751,029. The disclosed method includes depositing a stream or bead of plasticated thermoplastic material onto a heated first open mold section, closing a second heated mold section on the first mold section to seal the plasticized thermoplastic material within a cavity defined by the mold sections, pressing the molds together to distribute the plastic material throughout the cavity, cooling the mold to solidify a thermoplastic article, and removing the resulting compression molded thermoplastic article from the mold. The step of depositing plasticized thermoplastic material on the first mold section is achieved by plasticizing the thermoplastic material in an extruder which discharges the plasticized (melted) thermoplastic material into an accumulator equipped with a valve for controlling discharge of the thermoplastic material onto the open mold. While this technique has certain advantages over known injection molding and extrusion processes, including lower costs for the production of seamless thermoplastic articles having a relatively large dimension, and optionally having discrete inserts and/or uniformly distributed aesthetic particles (visible at a surface of the article), there are certain aspects of the process wherein improvements would be desirable. One aspect of the process in which improvement may be desirable relates to the fact that finite elements or bundles of the plasticated material in the accumulator can have substantially different residence times in the accumulator. In particular, plasticated material that is closer to the walls of the accumulator will tend to have longer residence times than plasticated material that is far removed from the walls of the accumulator. The result is that long term heating of portions or bundles of plasticated material that experience an extended residence time relative to the average residence time can result in degradation, decomposition or burning of portions of the material discharged from the accumulator, which, in turn, can result in discoloration, loss of homogeneity, and/or loss of physical properties, resulting in a finished article having unacceptable aesthetic and/or mechanical properties.

### SUMMARY OF THE INVENTION

In accordance with an aspect of the invention, a compression molding process and apparatus incorporates a reciprocating screw plasticator to reduce or eliminate problems associated with variations in the amount of time that thermoplastic material is maintained in a plasticated (melted) state.

These and other features, advantages and objects of the present invention will be further understood and appreciated by those skilled in the art by reference to the following specification, claims and appended drawings.

### BRIEF DESCRIPTION OF THE DRAWINGS

FIG. 1 is an elevational cross section of a mold that may be used in accordance with the process of this invention.

FIG. 2 is a side elevational view of a reciprocating screw plasticator.

FIG., 3 is an elevational cross section of the plasticator shown in FIG. 2, with plasticated material filling a volume between a check ring and a shut-off mechanism.

FIG. 4 is an elevational cross section of the plasticator shown in FIG. 2, with plasticated material being discharged onto a mold.

### DESCRIPTION OF THE PREFERRED EMBODIMENTS

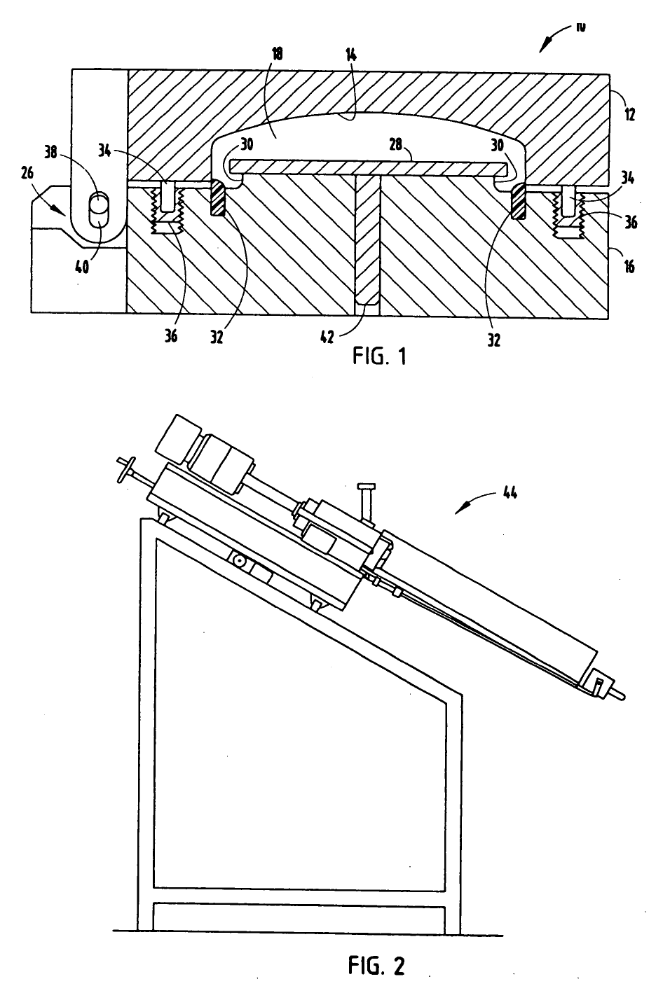

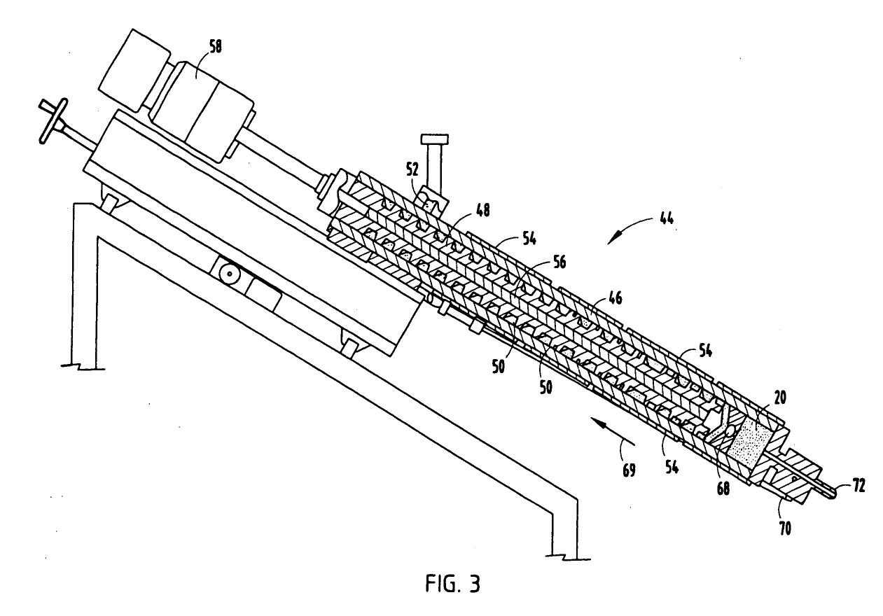

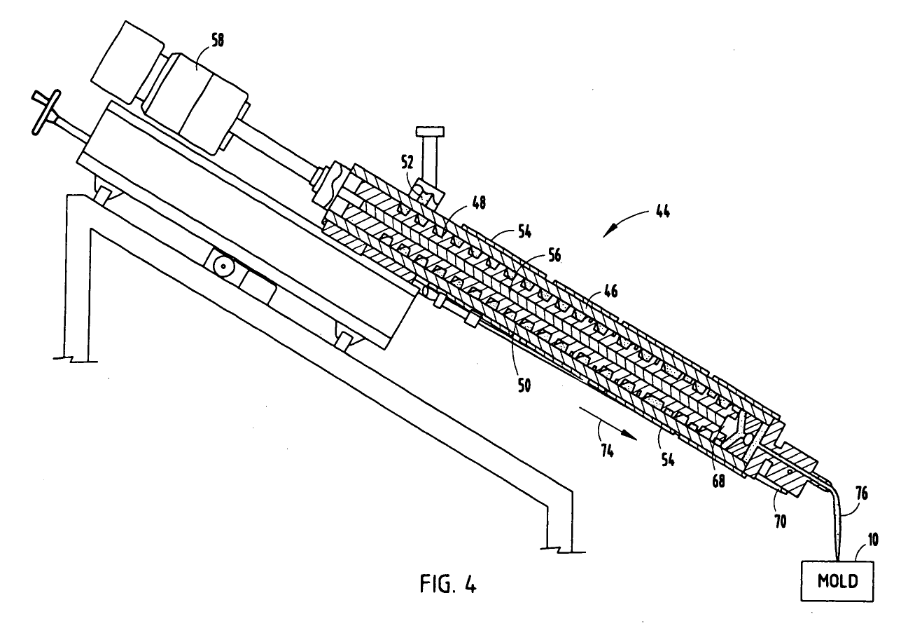

The process of this invention generally comprises steps of providing a thermally controlled mold 10 (FIG. 1) having a first section 12 and a second section 16, which together define a mold cavity 18; plasticating thermoplastic material 20 (FIG. 3) in a reciprocating screw extruder or plasticator 44 (FIGS. 2, 3, and 4); depositing a mass of plasticated thermoplastic material from a nozzle 72 at the discharge end of the plasticator onto one of the sections of the mold; closing the mold sections together to enclose the semi-solid mass of plasticated thermoplastic material in the mold cavity; cooling the thermoplastic material in the mold cavity to solidify a thermoplastic article; and removing the shaped article from the mold.

The term “mold” as used throughout the description and claims refers to a tool used for forming and shaping a specific article or product. Illustrated mold 10 has a first section 12 defining a recess 14, and a second section 16 joined to first section 12 by a hinge 26. Depending on the design of the thermoplastic articles being produced, cavity 18 may be defined by a recess in either or both of the mold sections 12 and 16.

In the illustrated embodiment, second mold section 16 includes a seat 28 on which an insert or reinforcement which will become part of the molded product may be positioned. The illustrated mold includes channel-like recesses 30 on each of the sides of seat 28. A shut-off dam 32 fabricated of a suitable wear resistant material such as polytetrafluoroethylene (PTFE) and designed to seat tightly against the face or wall of cavity 18 when the mold is closed is provided. Spaced outwardly from each side of dam 32 are stop pins 34 seated in threaded bushings 36 which are arranged to permit the extension of stop pins 34 above the top surface of mold section 16 to permit precise adjustment of the size of the available space within cavity 18. Stop pins 34 also assure an effective seal between dam 32 and the cavity wall by limiting and controlling closure of mold 10.

Hinge 26 is designed to accommodate this adjustment by permitting the final closing movement of first mold section 12 to be vertical rather than arcuate. This is possible because hinge 26 incorporates a lost motion connection. Hinge pin 38 on second mold section 16 is seated in a vertical slot 40 that permits limited vertical travel of first mold section 12 so that its final closing movement and its initial opening movement can be vertical. This permits a seal to be effected against dam 32 during closing before the final closing movement is made seating first mold section 12 on pins 34 of second mold section 16. Thus, a charge of thermoplastic material deposited on second mold section 16 will be confined within cavity 18 and cannot lose any of its volume by escaping the cavity. This arrangement coupled with accurate measurement of the volume of the charge assures creation of the necessary molding pressure while keeping the molding pressure to a minimum. The vertical travel also permits the mold to be released from any surface ornamentation during opening of the mold before arcuate movement of first mold section 12 with respect to second mold section 16. This arrangement also allows the first mold section when open to be seated in a stable, vertical position offset from the second mold section to provide access for charging the mold.

Mold 10 may also include one or more knock-out pins 42 for facilitating removal of a molded article. Pins 42 may be aligned with studs used for securing the article to an end product, such as a vehicle. In this case, studs can be preassembled to reinforcement and inserted in the pin openings to mount them in the mold. If reinforcement is not used, the pins can be equipped with a suitable head to be molded into the body of plastic and serve the same functional purposes during molding and subsequent use of the molded product.

Molds 10 are designed for low pressure molding and, therefore, can be less massive and made from lighter weight materials such as aluminum, and may be advantageously employed in a continuous production line.

A reciprocating screw plasticator 44 suitable for use in the process of this invention is shown in FIG. 2. As shown in FIG. 3, plasticator 44 includes a barrel 46 and a screw 48 mounted in barrel 46. Screw 48 includes threads 50 that remain in contact with internal walls of barrel 46 during rotation of screw 48 around an axis coinciding with an axis extending longitudinally through the centerline of barrel 46, and during linear movement of screw 48 with respect to barrel 46 along the longitudinal axis. Solid thermoplastic material, typically in the form of pellets, flakes or powder, enter space defined between threads 50 and between screw 48 and barrel 46 through a feed throat 52 at a rearward end or feed zone of plasticator 44. The channel depth (i.e., the distance from the land of the screw flight to the root diameter) is sufficient to provide positive conveyance of the thermoplastic material along the helical channel and to provide sufficient compression for densification of the solid thermoplastic material, as well as some frictional shearing forces at the polymer interface with the barrel and screw flight. This mechanical frictional energy, along with thermal conductive energy from exterior heating elements 54 and optionally from internal heating elements 56, causes the temperature of the polymer to rise as the screw conveys thermoplastic material toward the front or discharge end of the plasticator. Screw rotation may be provided by a rotary drive 58 (e.g., an electric motor). Linear movement of screw 48 along the longitudinal axis of barrel 46 may be achieved by actuating a plunger (not shown) using a hydraulic, pneumatic or electric servo actuating mechanism.

As thermoplastic material moves from the feed zone or rearward end of barrel 46 toward the forward or discharge end of the barrel, the thermoplastic material begins to melt and is fully plasticated or melted when it reaches the discharge end of screw 48. The plasticized material is deposited in a volume in front of the discharge end of screw 48. A check ring or backflow valve 68 mounted on the discharge end of screw 48 prevents plasticized material from re-entering the screw channels. As additional plasticated material is deposited in the space forward of the discharge end of the screw and forward of the check valve 68, screw 48 continues to rotate and retract away from the discharge end of plasticator barrel 46 in the direction indicated by arrow 69 (FIG. 3) until a predetermined or measured volume of plasticated material is contained within the space between check valve 68 and a shut-off mechanism 70 located adjacent discharge nozzle 72. The precise volume of plasticated material contained in the space between check valve 68 and shut-off mechanism 70 may be correlated to the position of screw 48 relative to barrel 46. When the appropriate volume of plasticized thermoplastic material has entered the volume between check valve 68 and shut-off mechanism 70, thermally controlled mold 10 is positioned below nozzle 42 and may be linearly moved with respect to nozzle 42 at a prescribed or predetermined rate while shut-off mechanism 70 is open and screw 48 is moved linearly forward toward the front or discharge end of barrel 46 as indicated by arrow 74 to cause a precisely measured shot 76 of plasticated thermoplastic material to be discharged from nozzle 72 onto mold section 16. Mold 10 can be thermally controlled to precisely achieve a desired constant temperature. By appropriate control of the movement of mold 10 relative to nozzle 72 during discharge of plasticated thermoplastic material from nozzle 72, in conjunction with an appropriate prescribed rate of movement of screw 48 relative to barrel 46 (which, depending on the article to be molded, may be a constant or variable linear rate of movement), it is possible to very precisely deposit a bead or parison of plasticized thermoplastic material on mold section 16 so that the flow of thermoplastic material during compression molding is minimal. This allows employment of relatively low compression forces during the compression molding process, and the use of aesthetic particles in the plasticized material to form molded articles having visible particles at the surface that are uniformly distributed over the surface to provide an aesthetically acceptable decorative effect. A bead of thermoplastic material can be precisely deposited on mold 10 such as by using a servo-driven xyz-positioning apparatus to create complex shapes.

By utilizing a reciprocating screw plasticator, it is possible to achieve a thoroughly mixed homogenous melt in which there is very little variation in the residence time of thermoplastic material for any particular metered shot used for forming a single article. Further, use of the reciprocating screw plasticator in which a given shot size is determined by the volume between the shut-off mechanism and a check valve at the discharge end of the screw allows very precise metering that can be accurately correlated to the position of screw 48 in barrel 46. In contrast, the previously known methods utilizing an accumulator and timed opening and closing of a discharge valve are subject to inaccuracies due to relatively minor variances in the theological properties of the plasticized material, which may be due to minor temperature variations and/or compositional variations.

In addition, the use of a reciprocating screw in accordance with the processes of this invention ensures that essentially all material introduced into the plasticator is discharged into a mold without experiencing a long residence time in the plasticator. In other words there are not any significant quantities of thermoplastic materials that remain in the plasticator for more than one cycle (reciprocation of the screw). The overall effect is that discrete packets of thermoplastic material are discharged into a mold in the same order that they enter the plasticator (i.e., first in, first out). This is significant because it ensures that thermally sensitive thermoplastic material, such as PVC, are not retained in the plasticator and exposed to high temperatures for a prolonged time which would cause degradation and production of inferior products.

Another advantage of the process of the invention is that it allows inserts, such as film, fasteners, nameplates, etc., to be placed in the mold and incorporated into a molded article without disruption of the quality of the surface of the finished article. More specifically, the process provides molded articles with inserts, which have superior surface quality as compared with similar articles produced using injection molding techniques.

As an option, instead of laying inserts onto the mold, a second plasticator can be used to deposit insert material onto a mold section before plasticated thermoplastic material is deposited from the main plasticator to provide a cover material parison over the insert material prior to closing and pressurization. This technique could also be used to make composite articles that incorporate less expensive filler material that is covered (skinned over) with a higher grade exterior material.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A process for making a thermoplastic article, comprising:
providing a mold having a first section and a second section which together define a mold cavity;
plasticating thermomplastic material in a reciprocating screw plasticator, the reciprocating screw plasticator including a screw that is rotatable and linearly movable in a barrel, a discharge nozzle having a shut-off mechanism located at a discharge end of the barrel, and a check valve mounted on the discharge end of the screw;
conveying thermoplastic material from a feed end of the barrel to the discharge end of the barrel by rotation of the screw while heating and plasticating the thermoplastic material;
retracting the screw away from the discharge end of the barrel while plasticated thermoplastic material passes through the check valve into a volume defined between the shut-off mechanism and the check valve until a predetermined volume of plasticated thermoplastic material is contained within the volume defined between the shut-off mechanism and the check valve;
opening the shut-off mechanism and advancing the screw toward the discharge end of the barrel to discharge the plasticated thermoplastic material from the nozzle of the plasticator and onto the first section of the mold;
closing the mold sections together to enclose the plasticated thermoplastic material in the mold cavity;
compressing the mold sections together;
cooling the thermoplastic material in the mold cavity to solidify an article; and
opening the mold and removing the article from the mold.

2. The process of claim 1, wherein the mold is thermally controlled.

3. The process of claim 1, further comprising placement of at least one insert onto the first section of the mold prior to discharging plasticated thermoplastic material onto the first section of the mold.

4. The process of claim 3, wherein the insert is a fastener.

5. The process of claim 3, wherein the insert is a film.

6. The process of claim 1, wherein at least one of the first and second mold sections includes a dam that seats against an internal wall of the other mold section to provide a seal that confines thermoplastic material deposited onto the first mold section from escaping from the mold cavity when the mold sections are compressed together.

7. The process of claim 1, wherein the mold sections are hinged together, the hinge including a hinge pin on one of the mold sections seated in a vertical slot defined by the other mold section to provide a lost motion connection that permits limited vertical travel of one mold section with respect to the other during a final closing movement and/or an initial opening movement.

8. The process of claim 1, wherein the first section of the mold is linearly moved with respect to the discharged nozzle of the plasticator during discharge of the plasticized thermoplastic material onto the first section of the mold.

9. A process for making a composite thermoplastic article, comprising:
providing a mold having a first section and a second section which together define a mold cavity;
plasticating a thermoplastic material in a first reciprocating screw plasticator;
discharging the first plasticated thermoplastic material from the plasticator onto the first section of the mold;
plasticating a second thermoplastic material in a reciprocating screw plasticator;
discharging the second plasticated thermoplastic material from the second plasticator onto the first section of the mold and onto the first plasticated thermoplastic material discharged onto the first section of the mold;
closing the mold sections together to enclose the plasticated thermoplastic materials in the mold cavity;
compressing the mold sections together;
cooling the thermoplastic materials in the mold cavity to solidify a composite thermoplastic article; and
opening the mold and removing the composite article from the mold.
